(19) United States
(12) Patent Application Publication
(10) Pub. No.: US 2026/0122459 A1
(43) Pub. Date: Apr. 30, 2026

(54) Controlling a Motor Vehicle

(71) Applicant: Bayerische Motoren Werke Aktiengesellschaft, Muenchen (DE)

(72) Inventor: Marco HIPPLER, Muenchen (DE)

(21) Appl. No.: 19/365,328

(22) Filed: Oct. 22, 2025

(30) Foreign Application Priority Data
Oct. 29, 2024 (DE) 10 2024 131 459.1

(51) Int. Cl. H04W 4/40; B60R 25/24; H04W 60/00

(52) U.S. Cl. CPC H04W 4/40; B60R 25/241; H04W 60/00; B60R 2325/101; B60R 2325/103; B60R 2325/108; B60R 2325/205

(57) ABSTRACT

A method for controlling a motor vehicle includes steps of registering a first mobile device to a user account; pairing the first mobile device with the motor vehicle as an owner device; generating a group identifier for the user account and transferring the group identifier to the motor vehicle. The method further includes steps of registering a second mobile device to the user account; transferring the group identifier to the second mobile device; and pairing the second mobile device with the motor vehicle as an owner device. Pairing involves transmitting the group identifier to the motor vehicle. The pairing of the first mobile device with the motor vehicle is maintained if a group identifier received from the second mobile device matches the group identifier of the user account.

### CROSS REFERENCE TO RELATED APPLICATION

This application claims priority under 35 U.S.C. §119 from German Patent Application No. 102024131 459.1, filed October 29, 2024, the entire disclosure of which is herein expressly incorporated by reference.

### BACKGROUND AND SUMMARY OF THE INVENTION

The present invention relates to the control of a motor vehicle. In particular, the invention relates to pairing a mobile device with a motor vehicle that is secured by means of a digital vehicle key.

A motor vehicle is secured by means of a digital vehicle key. The vehicle key may be implemented in particular in accordance with the specifications of the Car Connectivity Consortium (CCC), as published in the relevant technical specification. A predetermined security function of the motor vehicle, for example unlocking a vehicle door or tailgate or starting a drive motor, can be performed only after authentication with a mobile device via a wireless communication interface has taken place.

The motor vehicle can be controlled from the role of a user or that of an owner. Certain functions of the digital vehicle key are reserved for the owner role. In order to control such a function, it is necessary for the mobile device used to be an owner device that is paired with the motor vehicle in a predetermined manner.

If an owner possesses a mobile device that has already been paired and then acquires a new mobile device, the new device can be paired with the motor vehicle, the old device being unpaired from the motor vehicle. Vehicle keys that have been issued or signed by means of the old device cannot be deleted, but rather can be administered using the new device.

Sometimes, however, the owner may wish to continue to use their old device in addition to the new one. An object underlying the present invention is to provide an improved technique for pairing a mobile device as an owner device with a motor vehicle that is secured according to the concept of a digital vehicle key. The invention achieves this object by means of the subjects of the independent claims. Dependent claims provide preferred embodiments.

According to a first aspect of the present invention, a method for controlling a motor vehicle comprises steps of registering a first mobile device to a user account; pairing the first mobile device with the motor vehicle as an owner device; generating a group identifier for the user account; and transferring the group identifier to the motor vehicle. Furthermore, the method comprises steps of registering a second mobile device to the user account; transferring the group identifier to the second mobile device; and pairing the second mobile device with the motor vehicle as an owner device. Pairing the second mobile device involves transmitting the group identifier from the second mobile device to the motor vehicle. It is a proposal to maintain the pairing of the first mobile device with the motor vehicle if the group identifier received from the second mobile device matches the group identifier of the user account.

The method described does not require the motor vehicle to have, at the time of pairing with the second mobile device, a connection to an external data source from which the information as to whether both mobile devices are associated with the same user account can be obtained. Nevertheless, the applicable information is available when the second mobile device is paired with the motor vehicle. At this time, the second mobile device may not yet store a cryptographic key for controlling the motor vehicle.

It should be noted that continued control of a security function of the motor vehicle requires another cryptographic key that can be stored on the mobile device. An authentication procedure between the motor vehicle and the mobile device on the basis of the cryptographic key is usually performed by Bluetooth. The mobile device is paired with the motor vehicle, on the other hand, preferably by means of NFC (Near Field Communication).

The technique described allows an owner to pair multiple mobile devices with the motor vehicle without thereby unpairing another mobile device if both devices are associated with the same user.

The first mobile device can be unpaired from the motor vehicle, on the other hand, if no or a different group identifier than that of the user account of the first mobile device is received from the second mobile device. This may be the case, for example, when the motor vehicle is handed over from one owner to a new owner. As the second mobile device is not registered to the same user account as the first, it cannot present the appropriate group identifier and is treated as a new mobile device of an owner of the motor vehicle.

The group identifier for the user account of the first mobile device is preferably determined as part of a validation of a digital vehicle key for the motor vehicle. The digital vehicle key is then stored on and attached to the first mobile device.

The validation is usually performed by a key manager, which may be implemented as a service external to the motor vehicle, for instance in a cloud, or as a server. The key manager can manage keys for a large number of motor vehicles and, in each case, track which key exists for which motor vehicle. Validation can involve cryptographically signing the vehicle key.

An attestation of the validated vehicle key can be transferred from the key manager for digital vehicle keys to the motor vehicle. It is preferred for the specific group identifier to be transferred to the motor vehicle as part of this attestation. The attestation can involve transferring an attestation package from the key manager to the motor vehicle, and the group identifier may be included in the attestation package. The attestation package announces a generated digital vehicle key to the motor vehicle, so that the vehicle key can be presented on the motor vehicle in order to control a predetermined security function.

In fact, the user account is usually associated not with a device but rather with a person. In the present case, the person is an owner of the motor vehicle or fills the role of the owner of the motor vehicle. The owner may be a natural person, an institution or a device.

Certain functions of the mobile device can be controlled only after a user has authenticated themselves as a person to the mobile device, for example by presenting a biometric feature or by entering a predetermined secret. An identity of the user determined in this way may be associated with the user account.

The user account can be held on a user manager for users of mobile devices. If, for example, the mobile device is an Apple smartphone, the user account can comprise an AppleID. If the mobile device uses Android as its operating system, the user account can comprise a Google ID. The mobile device can also support another user manager, which is preferably organized centrally.

As part of the pairing of the first mobile device with the motor vehicle or as part of the generation of a cryptographic digital vehicle key on the first mobile device, it is possible to check to which user account the user handling the mobile device is registered. This can be accomplished by making an appropriate request to the user manager. The user manager can transfer an indication of the user account being used to the key manager. Preferably, an identification of the user account is transferred not in plain text but rather in a derived form, in particular by way of a hash, in this case.

The indication is preferably unique to the user account, and the group identifier is unique to the indication. Preferably, the group identifier does not comprise the indication in plain text either, but rather is derived from the indication, for example by way of another hash.

It is also proposed that matching indications from different user managers are assigned different group identifiers. Different user managers can each ensure that indications they provide with regard to group identifiers are unique, so that no two different user identifiers are associated with the same group identifier. If the key manager works with different user managers, however, then two different user managers could provide identical indications that, however, indicate different user accounts. It is therefore proposed that when determining a group identifier, consideration should be given to an identification of a user manager from which an indication of a user account has been received. For example, a hash can be created on the basis of an identification of the user manager and the indication. This in effect prevents different users from ultimately being associated with the same group identifier.

According to another aspect of the present invention, a control device for controlling a motor vehicle is proposed. The control device comprises a first interface for communicating with a mobile device; a second interface for communicating with a key manager for digital vehicle keys; and a processing apparatus. In this case, the processing device is designed to receive from the key manager a group identifier of a user account to which a first mobile device was registered when it was paired with the motor vehicle as an owner device; to receive another group identifier from a second mobile device as part of a pairing of the second mobile device as an owner device; and to maintain the pairing of the first mobile device if a group identifier received from the second mobile device matches the group identifier of the user account.

As part of a method described herein, the control device can act in place of the motor vehicle. If, for example, the motor vehicle is mentioned herein as providing a response to a request, the request can actually be answered by the control device. Preferably, the control device is also designed to check a digital vehicle key that is stored on a mobile device. A predetermined security function of the motor vehicle cannot be controlled until the check has had a positive outcome.

According to another aspect of the present invention, a motor vehicle comprises a control device described herein. The motor vehicle can include, in particular, a motorcycle, an automobile, a truck or a bus.

According to yet another aspect of the present invention, a mobile device is proposed. The mobile device comprises a first interface for communicating with a motor vehicle; a second interface for communicating with a user manager; and a processing apparatus. The processing apparatus is designed to control a registration of the mobile device in a user account of the user manager; and to control a pairing of the mobile device with the motor vehicle as an owner device via the first interface. The pairing is performed using a group identifier received from the user manager.

The mobile device may be the first or the second mobile device for a method described herein. The mobile device is preferably associated with a person as a personal device and can in particular include a smartphone. In other embodiments, the mobile device can also include, for example, a smart band, a smartwatch, a smart ring, a tablet computer, a laptop computer or a dedicated device, which in one embodiment may be known as a fob.

According to another aspect of the present invention again, a key manager for digital vehicle keys is presented. The key manager is designed to receive an indication of a user account to which a mobile device is registered while it is paired with a motor vehicle as an owner device; to take the indication as a basis for generating a group identifier; and to transfer the group identifier to the motor vehicle.

The key manager can provide additional services as part of the technology of a digital vehicle key. In particular, the key manager may be designed to digitally sign and validate a newly generated digital vehicle key for a motor vehicle. Validation can involve generating and transferring an attestation package on the basis of the digital vehicle key to the motor vehicle in question.

A system is also proposed that comprises a motor vehicle described herein, a mobile device described herein and a key manager described herein. One or more components of the system can comprise a processing apparatus that is designed to perform part or all of a method described herein.

For this purpose, the processing apparatus can be electronic and include, for example, an integrated circuit, a programmable logic chip or a programmable microcomputer. The method may be implemented in the form of a configuration or as a computer program product having program code means for the processing apparatus. The configuration or the computer program product may be stored on a computer-readable data carrier. Features or advantages of the method can be transferred to the device or vice versa.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a system with a motor vehicle; and

FIG. 2 illustrates a flow diagram of a method

### DETAILED DESCRIPTION OF THE DRAWINGS

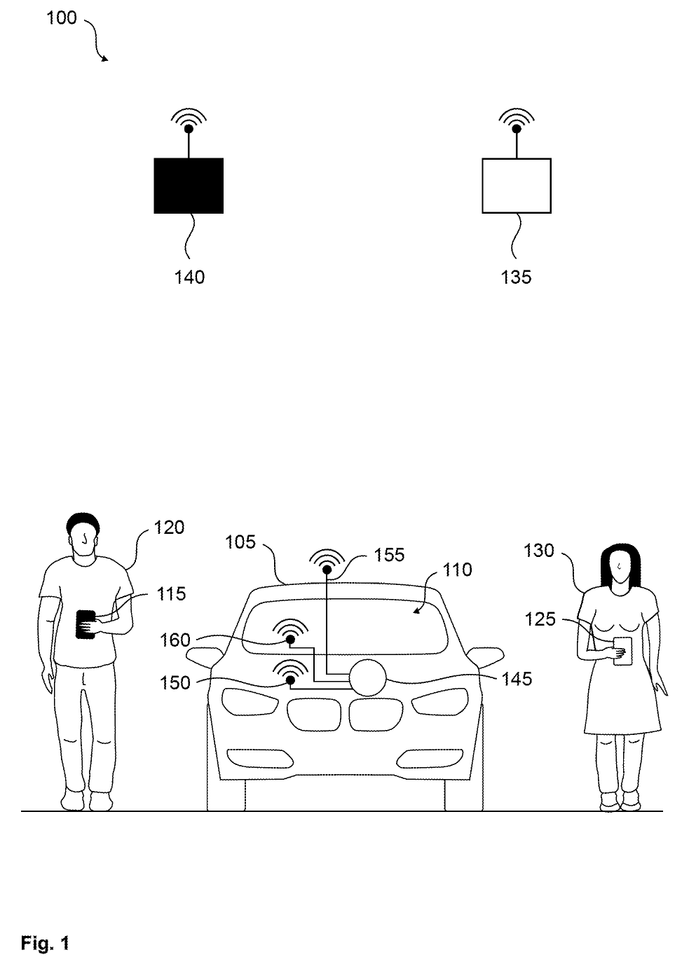

FIG. 1 shows a system 100 with a motor vehicle 105 that is secured according to the concept of a digital vehicle key implemented in particular according to the proposals of the CCC. For this purpose, the motor vehicle 105 comprises a control device 110.

More preferably, the system 100 comprises a first mobile device 115, which is associated here as an example with a first person 120, a second mobile device 125, which is associated here as an example with a second person 130; and also a key manager 135 and a user manager 140. The key manager 135 and the user manager 140 may also be integrated with each other.

In the embodiment shown, different persons 120, 130 are associated with the mobile devices 115 and 125. With regard to a technique presented herein, this situation is typical when the motor vehicle 105 is handed over from the first person 120 as the owner to the second person 130 as the owner. For another application described herein, however, it can be assumed that the persons 120 and 130 are identical and use two different mobile devices 115, 125.

The user manager 140 is designed to check an identity of a user 120, 130 of a mobile device 115, 125 or to make a corresponding association. A person 120, 130 can, for example, authenticate themselves to the mobile device 115, 125 by presenting a biometric feature or by entering a predetermined secret (PIN). Another authentication can be performed between the mobile device 115, 125 and the user manager 140.

The key manager 135 is designed to manage cryptographic digital vehicle keys that can be stored on mobile devices 115, 125 in order to control a security function of a motor vehicle 105. For this purpose, the key manager 135 can validate a transferred digital vehicle key by cryptographically signing the key.

Validation can involve generating and transferring an attestation package to the motor vehicle 105. Additionally, the key manager 135 can keep records of issued digital vehicle keys of the motor vehicle 105. This means that it is possible to precisely record which digital vehicle key with which permissions was generated, deleted or provided at what time.

The control device 110 is designed to control a predetermined security function of the motor vehicle 105, in particular opening a central locking system or releasing an immobilizer, on the basis of the technology of a digital vehicle key. For this purpose, the control device 110 comprises a processing apparatus 145, a first wireless interface 150 for communicating with a mobile device 115, 125 and a second wireless interface 155 for communicating with the key manager 135 and/or the user manager 140.

The first interface 150 preferably comprises near field communication (NFC) and operates over very short distances of usually less than approximately 10 cm. The second interface 155 can, for example, use mobile radio or WLAN, which allow greater transmission distances. More preferably, there is provision for a third wireless interface 160, which can comprise in particular Bluetooth (BT) or Bluetooth Low Energy (BLE). The third interface 160 can be used by the control device 110 to communicate in particular with a mobile device 115, 125.

The first interface 150 can be used to pair a mobile device 115, 125 with the motor vehicle 105, in particular as an owner device. Control of a security function of the motor vehicle 105 via the first interface 150 may also be possible.

The second interface 155 can be used to exchange information with the key manager 135 or the user manager 140. With regard to a technique described herein, however, the second interface 155 is usually not continually available. For example, if the motor vehicle 105 is in an underground garage, the second interface 155 may not be able to be used to exchange data.

The third interface 160 can be used to perform an authentication method for a cryptographic digital vehicle key, the vehicle key being stored on a mobile device 115, 125. A security function of the motor vehicle 105 can be controlled according to the result of such an authentication.

The first mobile device 115 can be paired with the motor vehicle 105 as an owner device. If the second mobile device 125 is then paired with the motor vehicle 105 as an owner device, a technique described herein can determine, as part of the pairing, whether the mobile devices 115, 125 are associated with the same user account of the same user manager 140. In this case, both mobile devices 115, 125 can co-exist as owner devices of the motor vehicle 105. Otherwise, if the mobile devices 115, 125 are associated with different user accounts or user managers 140, pairing the second mobile device 125 with the motor vehicle 105 can unpair the first mobile device 115 from the motor vehicle 105.

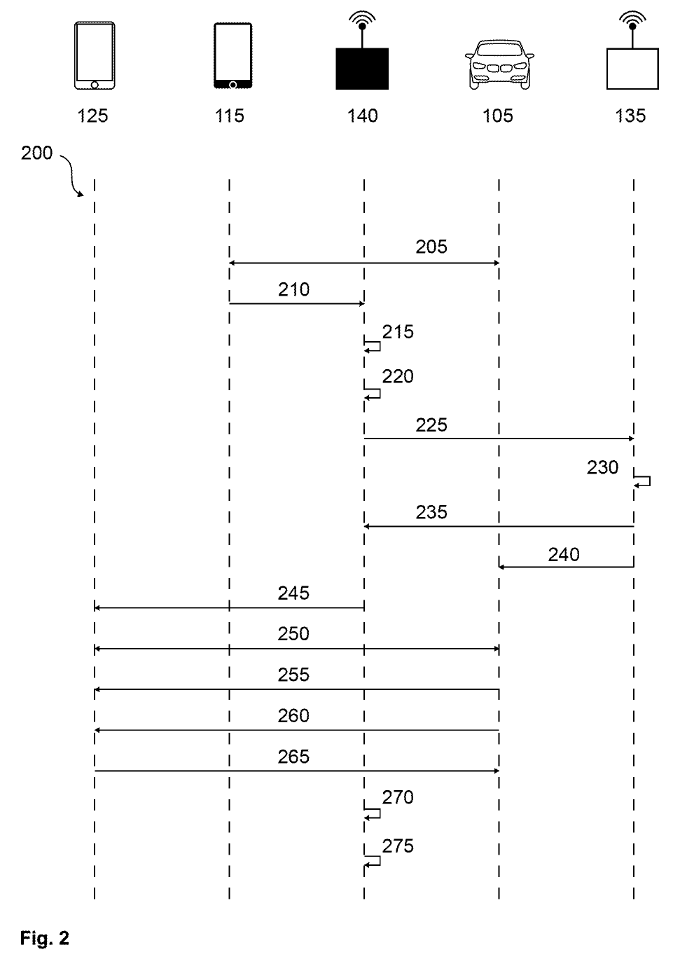

FIG. 2 shows a flow diagram of an example method 200 for controlling the motor vehicle 105. The method 200 illustrates the technique proposed herein in an exemplary embodiment.

A time is presented in a vertical direction from top to bottom. The exact dimensions do not matter for explaining the proposed technique, but a sequence of horizontally represented steps can be read from the depiction. Vertical, broken lines correspond to elements of the system 100 between which information is exchanged in accordance with the method. The elements of the system 100 are indicated as symbols and by reference signs in the upper region of FIG. 2. From left to right, the second mobile device 125, the first mobile device 115, the user manager 140, the motor vehicle 105 with the control device 110 and the key manager 135 are shown.

In a first part of the method 200, the mobile device 115 is prepared for use with the motor vehicle 105.

In a step 205, the first mobile device 115 is paired with the motor vehicle 105 as an owner device. For example, this process is described in more detail in chapter 6 of version 4 of the CCC's digital vehicle key technical specification. Subsequently, in a step 210, a request from the first mobile device 115 to track a cryptographic digital vehicle key can be transferred to the user manager 140. The user manager 140 can prepare a corresponding request to the key manager 135 in a step 215. In a step 220, an indication of a user account to which the first mobile device 115 is registered can be determined. In a step 225, a request to track the digital vehicle key received in step 210 can be transferred from the user manager 140 to the key manager 135. The indication (accountIdHash) of the active user account is preferably transferred to the key manager 135.

In a step 230, the key manager 135 can store the transferred indication locally. Additionally, a group identifier can be derived from the indication and preferably from an identification of the user manager 140.

In a step 235, a response comprising the group identifier can be transferred back from the key manager 135 to the user manager 140. From there, the group identifier can be transferred to the first mobile device 115. Additionally, an identification of the digital vehicle key together with the group identifier can be transferred to the motor vehicle 105 in a step 240.

This completes the configuration of the first mobile device 115 for use of the motor vehicle 105. In a second part of the method 200, a new mobile device 125 is paired with the motor vehicle 105 as an owner device.

In a step 245, the second mobile device 125 can be registered to a user account of the user manager 140. If the user account has an associated group identifier, in particular in accordance with step 235, then the group identifier can be transferred to the second mobile device 125.

For the actual pairing of the second mobile device 125 with the motor vehicle 105 as an owner device, the pairing of the second mobile device 125 can be initiated in a step 250, as described in more detail in chapter 6 of revision 4 of the technical specification from the CCC. In a step 255, data can be transferred from the motor vehicle 105 to the second mobile device 125. In this case, a message WRITE DATA can be transferred, which is described in more detail in chapter 5 of the aforementioned specification for phase 2 of the pairing of an owner device. In a step 260, the message GET DATA can be used to request data. In response, the requested data can be transferred from the second mobile device 125 to the motor vehicle 105 in a step 265. These data preferably comprise the group identifier that the second mobile device 125 received in step 245.

In a step 270, the motor vehicle 105 can check whether the group identifier of the second mobile device 125 matches the group identifier of the first mobile device 115. If this is the case, then in a step 275 the second mobile device 125 can be paired with the motor vehicle 105 alongside the first mobile device 115 as an owner device. Otherwise, a pairing of the second mobile device 125 can be performed in such a way that the first mobile device 115 is unpaired from the motor vehicle 105 as an owner device.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### REFERENCE SIGNS

100 system

105 motor vehicle

110 control device

115 first mobile device

120 first person

125 second mobile device

130 second person

135 key manager

140 user manager

145 processing apparatus

150 first interface, in particular NFC

155 second interface, in particular WLAN, mobile radio

160 third interface, in particular BT or BLE

200 method

205 pair first mobile device as owner device

210 track key

215 create request from server to server

220 create accountIdHash / accountInfoHash

225 track key with accountIdHash

230 store accountIdHash, create groupIdentifier

235 track confirmation key

240 transfer keyID and groupIdentifier

245 transfer groupIdentifier

250 pair second mobile device as owner device

255 write data

260 fetch data

265 receive data response

270 groupIdentifier identical?

275 pair new mobile device as owner device

What is claimed is:

1. A method for controlling a motor vehicle, the method comprising the steps of:
registering a first mobile device to a user account;
pairing the first mobile device with the motor vehicle as an owner device;
generating a group identifier for the user account and transferring the group identifier to the motor vehicle;
registering a second mobile device to the user account;
transferring the group identifier to the second mobile device;
pairing the second mobile device with the motor vehicle as an owner device;
wherein pairing the second mobile device involves transmitting the group identifier from the second mobile device to the motor vehicle; and
wherein the pairing of the first mobile device with the motor vehicle is maintained when a group identifier received from the second mobile device matches the group identifier of the user account.

2. The method according to claim 1, wherein the first mobile device is unpaired when no or a different group identifier than that of the user account of the first mobile device is received from the second mobile device.

3. The method according to claim 1, wherein the group identifier for the user account is determined as part of a validation of a digital vehicle key for the motor vehicle.

4. The method according to claim 3, wherein the group identifier is transferred from a key manager for digital vehicle keys to the motor vehicle as part of an attestation of the validated vehicle key.

5. The method according to claim 1, wherein the user account is associated with a person.

6. The method according to claim 1, wherein the user account is held on a user manager for users of mobile devices.

7. The method according to claim 6, wherein an indication of the user account is transferred from the user manager to the key manager.

8. The method according to claim 7, wherein the indication is unique to the user account and the group identifier is unique to the indication.

9. The method according to claim 8, wherein matching indications from different user managers are assigned different group identifiers.

10. A control device for controlling a motor vehicle, the control device comprising:
a first interface for communicating with a mobile device;
a second interface for communicating with a key manager for digital vehicle keys;
a processing apparatus that is operatively configured to:
receive from the key manager a group identifier of a user account to which a first mobile device was registered when it was paired with the motor vehicle as an owner device;
receive another group identifier from a second mobile device as part of a pairing of the second mobile device as an owner device; and
maintain the pairing of the first mobile device when a group identifier received from the second mobile device matches the group identifier of the user account.

11. A motor vehicle comprising a control device according to claim 10.

12. A mobile device, comprising:
a first interface for communicating with a motor vehicle;
a second interface for communicating with a user manager; and
a processing apparatus that is operatively configured to:
control a registration of the mobile device in a user account of the user manager; and
control a pairing of the mobile device with the motor vehicle as an owner device via the first interface;
wherein the pairing is performed using a group identifier received from the user manager.

13. A manager for digital vehicle keys, comprising:
a key manager operatively configured to:
receive an indication of a user account to which a mobile device is registered while it is paired with a motor vehicle as an owner device;
take the indication as a basis for generating a group identifier; and
transfer the group identifier to the motor vehicle.

14. A system, comprising:
a motor vehicle;
first and second mobile devices; and
a key manager,
wherein the configured to carry out the acts of:
registering the first mobile device to a user account;
pairing the first mobile device with the motor vehicle as an owner device;
generating a group identifier for the user account and transferring the group identifier to the motor vehicle, wherein the group identifier for the user account is determined as part of a validation of a digital vehicle key for the motor vehicle, and further wherein the group identifier is transferred from the key manager for digital vehicle keys to the motor vehicle as part of an attestation of the validated vehicle key;
registering the second mobile device to the user account;
transferring the group identifier to the second mobile device;
pairing the second mobile device with the motor vehicle as an owner device;
wherein pairing the second mobile device involves transmitting the group identifier from the second mobile device to the motor vehicle; and
wherein the pairing of the first mobile device with the motor vehicle is maintained when a group identifier received from the second mobile device matches the group identifier of the user account.
